(19) United States
(12) Patent Application Publication
(10) Pub. No.: US 2010/0064528 A1
(43) Pub. Date: Mar. 18, 2010

(54) Scissors for accommodating different sized hands and for requiring a minimal force to close

(75) Inventor: Muhammad Habib, South Plainfield, NJ (US)

Correspondence Address: CHARLES E. BAXLEY, ESQUIRE, 90 JOHN STREET, SUITE 309, NEW YORK, NY, 10038, US

(73) Assignee: Franzo International Corp.

(21) Appl. No.: 12/283,660

(22) Filed: Sep. 15, 2008

(51) Int. Cl. B26B 13/12; B26B 13/00

(52) U.S. Cl. 30/232; 30/261

(57) ABSTRACT

Scissors for accommodating different sized hands and for requiring a minimal force to close. The scissors include a pair of handles, a pair of cutting jaws, and a spring. The pair of cutting jaws extend from the pair of handles so as to form a pair of shanks. The pair of shanks overlap each other at the pair of cutting jaws and are pivotally connected to each other by a pivot pin. The spring is operatively connected to the pair of handles, is so constructed so as to have a non-biased initial open position for accommodating the different sized hands, and is so located for requiring the minimal force to close the pair of handles from the non-biased initial open position.

### 1. BACKGROUND OF THE INVENTION

A. Field of the Invention

The embodiments of the present invention relate to scissors, and more particularly, the embodiments of the present invention relate to scissors for accommodating different sized hands and for requiring a minimal force to close.

B. Description of the Prior Art

Cutting implements and tools have been in use for hundreds of years for cutting hair, cloth, plants, paper, etc. Early on it was realized that cutting tools, such as a scissors or shears, where more efficient if the user only had to employ one hand to manipulate the tool. This left the other hand free to hold or guide the material during the cutting process. Thus, scissors were formed that had blades pivotally attached with handles having finger and thumb loops. The fingers and thumb of the hand were thus used to manipulate the blades into the open or cutting positions.

While the finger loop scissors are usable for many cutting projects, in certain situations they are unsuitable. For example, when accurate cutting is necessary, such as during emergency surgery, finger loop scissors can be unsuitable because they can be difficult to control due to the fact that the scissor is only being held by two fingers of one hand. When the user's fingers are covered with rubber gloves or slippery body fluids, the user's fingers can cause the scissor to slip. Further, finger loop scissors can be difficult to remove from a doctor's fingers when another surgery tool is needed. Another instance in which finger loop scissors can be unsuitable is when the scissor is used to cut bulky material, such as canvas, denim, etc. The grip of two scissor-holding fingers is relatively weak and it is often impossible to manipulate the scissors to cut an even line. Further, the pressure on the fingers necessary for releasing the blades from the cutting position can be painful and cause blistering of the skin.

Furthermore, finger loop scissors are sometimes inappropriate because the user is not sufficiently dexterous to be able to perform the scissoring movement of the two fingers required to open and close the scissor blades. Examples, of these users can include persons with various muscular diseases, small children, arthritic person, and handicapped persons.

Often finger loop scissors are designed in such a manner that one loop fits the thumb and the other loop fits the fingers of the right hand, thus making the scissors uncomfortable for use by the left handed.

It may be appreciated that it would be desirable to have, and there remains a need for, a scissor which does not require dexterity of the fingers and thumb for operation but instead can be easily controlled. There is further a need for a scissor that can be operated by using either the thumb or by applying a hand squeezing or gripping motion on handles to produce the cutting motion. Further, there is a need for a scissor which can be held and operated with the right or left hand. Furthermore, there is a need for a scissor which is biased to return to the open position so that the operator is only required to use downward pressure to place the blades in the cutting position as the biasing apparatus returns the blades to the open position, requiring less pressure strain on the muscles and skin of the scissoring fingers. Scissors with these traits would be especially helpful when bulky material is cut, or when scissors are used often, such as in fabric stores or textile factories, or when a precisely controlled cut is required, such as in surgery.

Numerous innovations for scissors have been provided in the prior art, which will be described below in chronological order to show advancement in the art, and which are incorporated herein by reference thereto. Even though these innovations may be suitable for the specific individual purposes to which they address, however, they differ from the present invention in that they do not teach scissors for accommodating different sized hands and requiring a minimal force to close.

(1) U.S. Pat. No. 244,508 to Woodward.

U.S. Pat. No. 244,508 issued to Woodward on Jul. 19, 1881 teaches scissors having a spring arranged between the interior opposite faces of their handle ends, and provided at its free end with an inclined extension or projection, which extends up alongside the adjoining handle end to exert lateral pressure thereon when the blades are closing.

(2) U.S. Pat. No. 1,472,392 to Harvey.

U.S. Pat. No. 1,472,392 issued to Harvey on Oct. 30, 1923 teaches an implement embodying relatively movable members provided with clipping jaws at one of their ends and handles at their other ends. The intermediate portions thereof are enlarged and have cavities therein. The cutting edges of the jaws are cupped for insertion into the stem pit of fruit. A stop member is held stationary in the cavities of the members and has a forwardly projecting lip with an edge extending transversely of the cutting edges for limiting the adjustment of the implement relative to the fruit stems in a clipping operation. A spring has the end portions thereof engaging the handles. The intermediate portions thereof engage portions of the stop member for holding the stop member in an operative position when the jaws are open and for holding the jaws normally closed.

(3) U.S. Pat. No. 1,870,025 to Rauh.

U.S. Pat. No. 1,870,025 issued to Rauh on Aug. 2, 1932 teaches self-opening scissors including a pair of shanks. Each shank embodies an operating handle provided with a cutting blade at one end. A pivot connects the shanks at a point between the cutting blades and the handles. The shanks are offset and broadened behind the pivot and unbroken by any openings in their broadened outer faces, and rounded on the exterior lines of these surfaces. One of the broadened portions is provided with a rearwardly opening recess and the other with an integral lug projecting into the recess to constitute a stop-opening apparatus. The recess is closed on all sides except rearwardly in all positions of the shanks. The shanks—adjacent to the offset portions—are rounded in cross section and substantially separated from each other when the scissors are closed. Spring opening apparatus operates between the shanks, whereby the scissors are prevented from pinching the hand of the user.

(4) U.S. Pat. No. 2,881,696 to Poth.

U.S. Pat. No. 2,881,696 issued to Poth on Apr. 14, 1959 in U.S. class 100 and subclass 234 teaches a fruit juice extractor including a first member having a pressure plate at the first end and a handle at a second end and an integral juice shield section depending from the lateral sides of the aforementioned pressure plate. Spaced wall portions join the pressure plate and the handle. The first member has an aperture defined, respectively, by the inner surfaces of the wall portions and by arcuate bearing surfaces on the plate and the handle. A second member has a second pressure plate at a first end and a second handle at a second end. The second pressure plate has apertures therethrough and lateral side edges adapted to engage within the depending shield portion. The second member has a generally cylindrical hub portion joining the second pressure plate and the second handle. The hub portion is adapted to seat rotatably upon the arcuate bearing surfaces, and to contact at its ends, the spaced wall portions of the first member to thereby prevent endwise slippage of the second member and to insure register of the first and second pressure plates as they are moved toward each other. Apparatus is for pivotally securing the hub portion in the first-mentioned aperture and resilient apparatus is interposed between the handles and holds the plates normally in a separated position.

(5) U.S. Pat. No. 5,168,629 to Willard.

U.S. Pat. No. 5,168,629 issued to Willard on Dec. 8, 1992 in U.S. class 30 and subclass 231 teaches a scissor assembly adapted to be in an open or closed position and to be manipulated by a user to cut a selected material. The scissors' assembly includes a first scissor member and a second scissor member pivotally connect and biased into and open position. The first scissor member has a handle and a blade. The first handle is formed as an enlarged and elongated shaft sized to fit in a user's palm and be gripped by the fingers. The second scissor member likewise has a handle and a blade. In the preferred embodiment, the first handle is formed as a releasable container and the second handle is foreshortened relative to the first handle. In the alternative embodiments, the first handle is formed of implements, such as a screw-driver, flashlight, or pliers. The scissors' assembly can also include a locking assembly to retain the closed position of the blades and a limit stop to limit the distance between the open position.

### (6) United States Patent Application Publication Number US 2004/0255731 A1 to Berg et al.

United States Patent Application Publication Number US 2004/0255731 A1 published to Berg et al. on Dec. 23, 2004 in U.S. class 81 and subclass 427.5 teaches a multi-purpose folding tool, including a pair of folding scissors, in which a scissors' blade is movable about a pivot shaft, between a stowed position and a deployed position. A rocker is moved by a spring in the tool handle and urges a movable scissors' blade toward an open position. In one embodiment, two handles are folded about respective scissors' blades to house the blades, and four springs hold the handles together with the folded scissors stowed within the handles. A pair of tweezers of sheet metal has a pair of parallel arms, each perpendicular to a base portion of the tweezers. When the scissors and other tools are folded into their stowed positions in the handle of the multi-purpose tool, the tool has a smooth outside configuration allowing the tool to be carried in a pocket without causing undue wear.

It is apparent that numerous innovations for scissors have been provided in the prior art that are adapted to be used. Furthermore, even though these innovations may be suitable for the specific individual purposes to which they address, however, they would not be suitable for the purposes of the embodiments of the present invention as heretofore described, namely, scissors for accommodating different sized hands and for requiring a minimal force to close.

### 2. SUMMARY OF THE INVENTION

Thus, an object of the embodiments of the present invention is to provide scissors for accommodating different sized hands and for requiring a minimal force to close, which avoids the disadvantages of the prior art.

Briefly stated, another object of the embodiments of the present invention is to provide scissors for accommodating different sized hands and for requiring a minimal force to close. The scissors include a pair of handles, a pair of cutting jaws, and a spring. The pair of cutting jaws extend from the pair of handles so as to form a pair of shanks. The pair of shanks overlap each other at the pair of cutting jaws and are pivotally connected to each other by a pivot pin. The spring is operatively connected to the pair of handles, is so constructed so as to have a non-biased initial open position for accommodating the different sized hands, and is so located for requiring the minimal force to close the pair of handles from the non-biased initial open position.

The novel features considered characteristic of the embodiments of the present invention are set forth in the appended claims. The embodiments of the present invention themselves, however, both as to their construction and their method of operation together with additional objects and advantages thereof will be best understood from the following description of the specific embodiments when read and understood in connection with the accompanying drawing.

### 3. BRIEF DESCRIPTION OF THE DRAWING

The figures of the drawing are briefly described as follows:

FIG. 1 is a diagrammatic top plan view of the scissors of the embodiments of the present invention in the normal open position;

FIG. 2 is a diagrammatic top plan view of the scissors of the embodiments of the present invention in the closed position;

FIG. 3 is a diagrammatic side elevational view taken generally in the direction of ARROW 3 in FIG. 1;

FIG. 4 is a diagrammatic end view taken generally in the direction of ARROW 4 in FIG. 3; and

FIG. 5 is an enlarged diagrammatic perspective view of the area generally enclosed by the dotted curve identified by ARROW 5 in FIG. 1.

### 4. LIST OF REFERENCE NUMERALS UTILIZED IN THE DRAWING

### A. General.

10 scissors of embodiments of present invention scissors for accommodating different sized hands and for requiring minimal force to close

### B. Overall Configuration of Scissors 10.

12 pair of handles
14 pair of cutting jaws
16 spring
18 pair of shanks
20 pivot pin

### C. Overall Configuration of Spring 16.

22 pair of spring-metal pieces of spring 16
24 proximal end of each spring-metal piece of pair of spring-metal pieces 22 of spring 16
26 free distal end of each spring-metal piece of pair of spring-metal pieces 22 of spring 16
28 proximal end of each shank of pair of shanks 18
30 distal end of each shank of pair of shanks 18
32 lever arms of pair of handles 12, respectively

### D. Specific Configuration of Spring 16.

34 through slot of distal end 26 of one spring-metal piece of pair of spring-metal pieces 22 of spring 16
36 pair of opposing side through notches of distal end 26 of other spring-metal piece of pair of spring-metal pieces 22 of spring 16
38 narrowed portion of distal end 26 of other spring-metal piece of pair of spring-metal pieces 22 of spring 16
39 pair of shoulders of narrowed portion 38 of distal end 26 of other spring-metal piece of pair of spring-metal pieces 22 of spring 16
40 cross piece of narrowed portion 38 of distal end 26 of other spring-metal piece of pair of spring-metal pieces 22 of spring 16
42 length of through slot 34 of distal end 26 of one spring-metal piece of pair of spring-metal pieces 22 of spring 16
44 length of narrowed portion 38 of distal end 26 of other spring-metal piece of pair of spring-metal pieces 22 of spring 16

### 5. DETAILED DESCRIPTION OF THE PREFERRED EMBODIMENTS

### A. General.

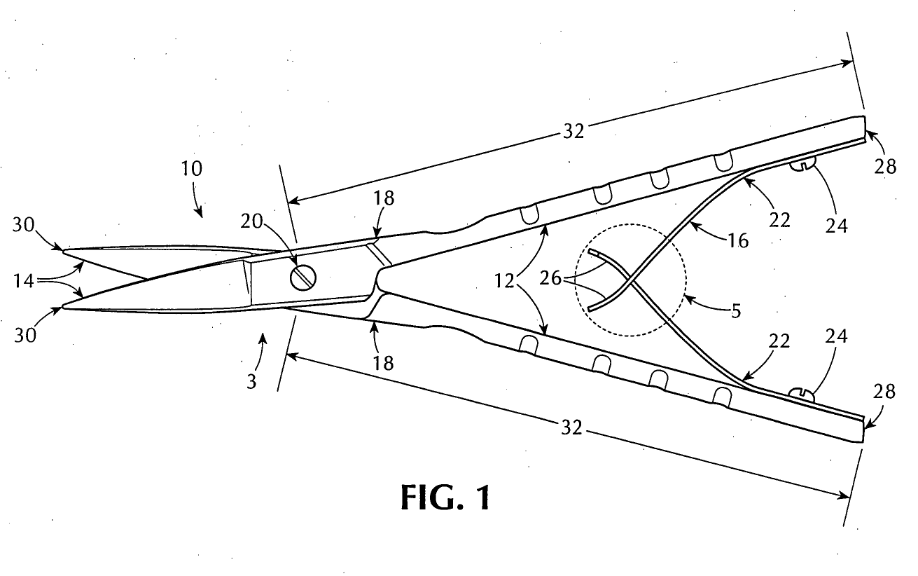

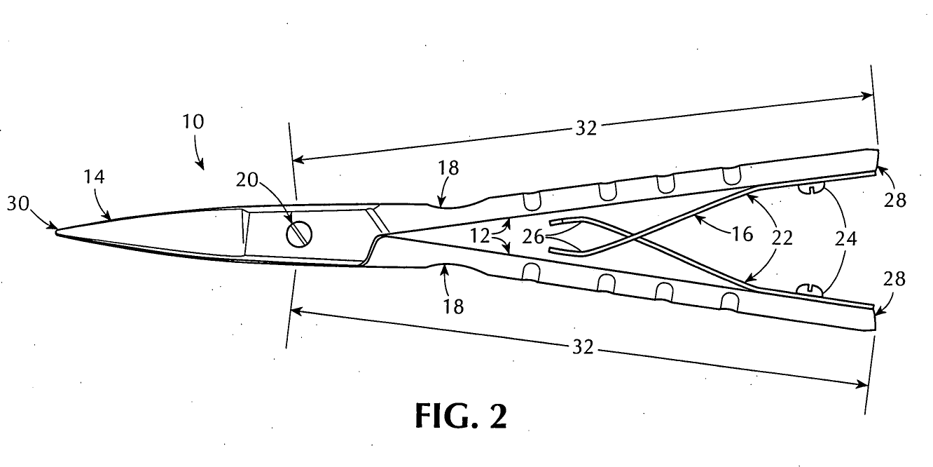

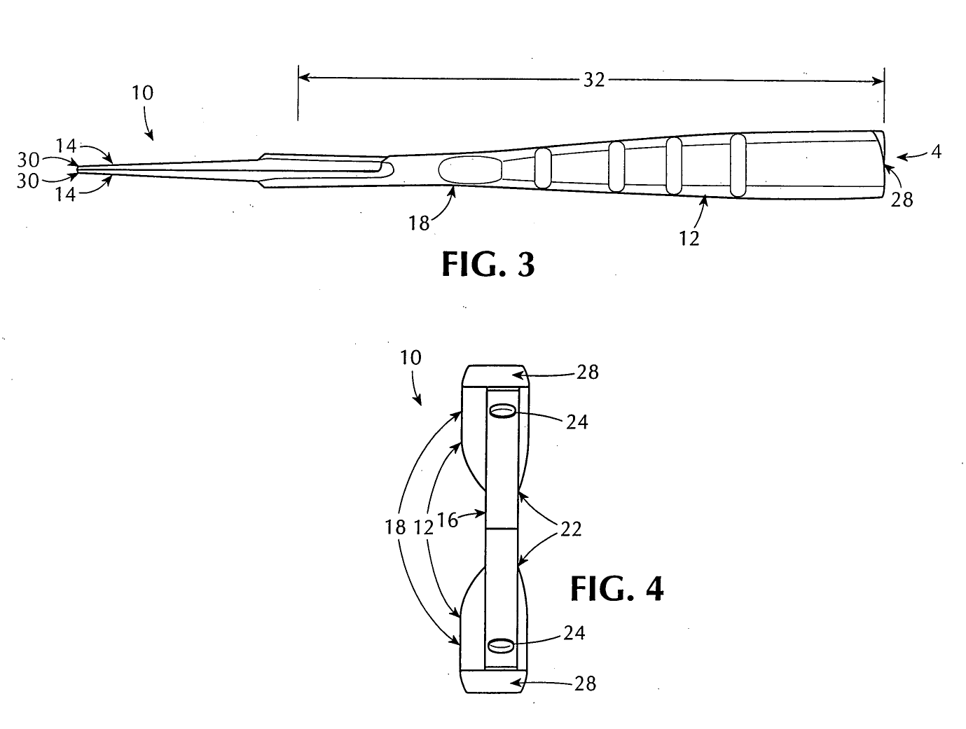

Referring now to the figures, in which like numerals indicate like parts, and particularly to FIGS. 1-4, which are, respectively, a diagrammatic top plan view of the scissors of the embodiments of the present invention in the normal open position, a diagrammatic top plan view of the scissors of the embodiments of the present invention in the closed position, a diagrammatic side elevational view taken generally in the direction of ARROW 3 in FIG. 1, and a diagrammatic end view taken generally in the direction of ARROW 4 in FIG. 3, the scissors of the embodiments of the present invention is shown generally at 10 scissors for accommodating different sized hands and for requiring a minimal force to close.

### B. The Overall Configuration of the Scissors 10.

The scissors 10 comprise a pair of handles 12, a pair of cutting jaws 14, and a spring 16. The pair of cutting jaws 14 extend from the pair of handles 12 so as to form a pair of shanks 18. The pair of shanks 18 overlap each other at the pair of cutting jaws 14 and are pivotally connected to each other by a pivot pin 20. The spring 16 is operatively connected to the pair of handles 12, is so constructed so as to have the non-biased initial open position for accommodating the different sized hands, and is so located for requiring the minimal force to close the pair of handles 12 from the non-biased initial open position.

### C. The Overall Configuration of the Spring 16.

The spring 16 comprises a pair of spring-metal pieces 22.

Each spring-metal piece 22 of the spring 16 has a proximal end 24 and a free distal end 26.

Each shank 18 has a proximal end 28 and a distal end 30.

The proximal end 24 of one spring-metal piece 22 of the spring 16 is disposed at the proximal end 28 of one shank 18 and extends forwardly and inwardly therefrom to the free distal end 26 of the one spring-metal piece 22, while the proximal end 24 of the other spring-metal piece 22 of the spring 16 is disposed at the proximal end 28 of the other shank 18 and extends forwardly and inwardly therefrom to the free distal end 26 of the other spring-metal piece 22, with the pair of spring-metal pieces 22 of the spring 16 urging the pair of handles 12 away from each other, and with the free distal ends 26 of the pair of spring-metal pieces 22 of the spring 16 interacting with each other.

With the free distal ends 26 of the pair of spring-metal pieces 22 of the spring 16 interacting with each other, which will be discussed further below, the scissors 10 have the non-biased initial open position for accommodating the different sized hands.

With the proximal ends 24 of the pair of spring-metal piece 22 of the spring 16 being disposed at the proximal ends 28 of the pair of shanks 18, respectively, the pair of handles 12 have longer lever arms 32 from the pivot pin 20 (fulcrum) to the proximal ends 28 of the pair of shanks 18, which in turn provide for the minimal force to close the pair of handles 12 from the non-biased initial open position against the urging of the spring 16.

With the pair of spring-metal pieces 22 of the spring 16 extending forwardly and inwardly from the proximal ends 24 of the pair of spring metal piece 22 of the spring 16, respectively, the spring 16 will not interfere with, and possibly pinch, the hand operating the scissors 10.

### D. The Specific Configuration of the Spring 16.

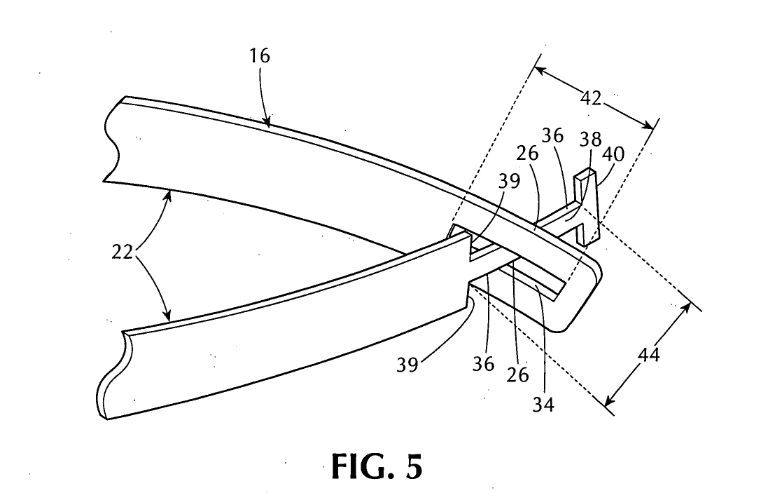

The specific configuration of the spring 16 can best be seen in FIG. 5, which is an enlarged diagrammatic perspective view of the area generally enclosed by the dotted curve identified by ARROW 5 in FIG. 1, and as such, will be discussed with reference thereto.

The distal end 26 of the one spring-metal piece 22 of the spring 16 has a through slot 34 extending axially therealong, while the distal end 26 of the other spring-metal piece 22 of the spring 16 has a pair of opposing side through notches 36 extending therealong and defining a narrowed portion 38 therebetween. The narrowed portion 38 of the distal end 26 of the other spring-metal piece 22 of the spring 16 originates in a pair of shoulders 39 and terminates in a cross piece 40 that both further define the narrowed portion 38 of the distal end 26 of the other spring-metal piece 22 of the spring 16

The through slot 34 of the distal end 26 of the one spring-metal piece 22 of the spring 16 movably receives the narrowed portion 38 of the distal end 26 of the other spring-metal piece 22 of the spring 16, and is maintained therein, by the cross piece 40 of the distal end 26 of the other spring-metal piece 22 of the spring 16.

The narrowed portion 38 of the distal end 26 of the other spring-metal piece 22 of the spring 16 moves freely in the through slot 34 of the distal end 26 of the one spring-metal piece 22 of the spring 16 as the pair of handles 18 are moved towards each other until the through slot 34 of the distal end 26 of the one spring-metal piece 22 of the spring 16 bottoms out on the pair of shoulders 39 of the narrowed portion 38 the distal end 26 of the other spring-metal piece 22 of the spring 16, thereby engaging the pair of spring-metal pieces 22 of the spring 16 with each other to bias the pair of handles 12 away from each other. Until this time, the spring 16 has no biasing, and as such, is in the non-biased initial open position thereby allowing the pair of handles 18 to move without the biasing of the spring 16 for accommodating the different sized hands.

The through slot 34 of the distal end 26 of the one spring-metal piece 22 of the spring 16 has a length 42 and the narrowed portion 38 the distal end 26 of the other spring-metal piece 22 of the spring 16 has a length 44. The length 42 of the through slot 34 of the distal end 26 of the one spring-metal piece 22 of the spring 16 is equal to the length 44 of the narrowed portion 38 the distal end 26 of the other spring-metal 22 of the spring 16.

### E. The Impressions.

It will be understood that each of the elements described above or two or more together may also find a useful application in other types of constructions differing from the types described above.

While the embodiments of the present invention have been illustrated and described as embodied in scissors for accommodating different sized hands and for requiring a minimal force to close, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. Scissors for accommodating different sized hands and for requiring a minimal force to close, comprising:
a) a pair of handles;
b) a pair of cutting jaws; and
c) a spring;
wherein said pair of cutting jaws extend from said pair of handles so as to form a pair of shanks;
wherein said pair of shanks overlap each other at said pair of cutting jaws;
wherein said pair of shanks are pivotally connected to each other by a pivot pin;
wherein said spring is operatively connected to said pair of handles;
wherein said spring is so constructed so as to have a non-biased initial open position for accommodating the different sized hands; and
wherein said spring is so located for requiring the minimal force to close said pair of handles from said non-biased initial open position.

2. The scissors of claim 1, wherein said spring comprises a pair of spring metal pieces;
wherein each spring-metal piece of said spring has:
a) a proximal end; and
b) a free distal end;
wherein each shank has:
a) a proximal end; and
b) a distal end.

3. The scissors of claim 2, wherein said proximal end of one spring metal-piece of said spring is disposed at said proximal end of one shank and extends forwardly and inwardly therefrom to said free distal end of said one spring-metal piece, while said proximal end of the other spring-metal piece of said spring is disposed at said proximal end of the other shank and extends forwardly and inwardly therefrom to said free distal end of said other spring-metal piece, with said pair of spring-metal pieces of said spring urging said pair of handles away from each other, and with said free distal ends of said pair of spring-metal pieces of said spring interacting with each other.

4. The scissors of claim 2, wherein said free distal ends of said pair of spring-metal pieces of said spring interact with each other so as to allow said scissors to have said non-biased initial open position for accommodating the different sized hands.

5. The scissors of claim 2, wherein said proximal ends of said pair of spring metal piece of said spring are disposed at said proximal ends of said pair of shanks, respectively, so as to allow said pair of handles to have longer lever arms from said pivot pin to said proximal ends of said pair of shanks, which in turn provide for the minimal force to close said pair of handles from said non-biased initial open position against urging of said spring.

6. The scissors of claim 2, wherein said pair of spring-metal pieces of said spring extend forwardly and inwardly from said proximal ends of said pair of spring metal piece of said spring, respectively, so as to prevent said spring from interfering with, and possibly pinching, the hand operating said scissors.

7. The scissors of claim 2, wherein said distal end of said one spring-metal piece of said spring has a through slot extending axially therealong;
wherein said distal end of said other spring-metal piece of said spring has a pair of opposing side through notches extending therealong;
wherein said pair of opposing side through notches of said distal end of said other spring-metal piece of said spring define a narrowed portion therebetween; and
wherein said narrowed portion of said distal end of said other spring-metal piece of said spring originates in a pair of shoulders and terminates in a cross piece that both define said narrowed portion said distal end of said other spring-metal piece of said spring.

8. The scissors of claim 7, wherein said through slot of said distal end of said one spring-metal piece of said spring movably receives said narrowed portion of said distal end of said other spring-metal piece of said spring; and
wherein said narrowed portion of said distal end of said other spring-metal piece of said spring is maintained in said through slot of said distal end of said one spring-metal piece of said spring by said cross piece of said distal end of said other spring-metal piece of said spring.

9. The scissors of claim 7, wherein said narrowed portion of said distal end of said other spring-metal piece of said spring moves freely in said through slot of said distal end of said one spring-metal piece of said spring as said pair of handles are moved towards each other until said through slot of said distal end of said one spring-metal piece of said spring bottoms out on said pair of shoulders of said narrowed portion said distal end of said other spring-metal piece of said spring, thereby causing said pair of spring-metal pieces of said spring to engage each other and bias said pair of handles away from each other, until this time, said spring has no biasing, and as such, is in said non-biased initial open position thereby allowing said pair of handles to move without said biasing of said spring for accommodating the different sized hands.

10. The scissors of claim 7, wherein said through slot of said distal end of said one spring-metal piece of said spring has a length;
wherein said narrowed portion said distal end of said other spring-metal piece of said spring has a length; and
wherein said length of said through slot of said distal end of said one spring-metal piece of said spring is substantially equal to said length of said narrowed portion said distal end of said other spring-metal piece of said spring.

11. The scissors of claim 1, wherein said pair of handles are straight; and
wherein said pair of handles are loopless.
